(19) United States
(12) Patent Application Publication
(10) Pub. No.: US 2024/0298381 A1
(43) Pub. Date: Sep. 5, 2024

(54) COMMUNICATION METHOD

(71) Applicant: KYOCERA Corporation, Kyoto (JP)

(72) Inventor: Masato FUJISHIRO, Yokohama-shi (JP)

(73) Assignee: KYOCERA Corporation, Kyoto (JP)

(21) Appl. No.: 18/646,442

(22) Filed: Apr. 25, 2024

Related U.S. Application Data
(63) Continuation of application No. PCT/JP2022/039136, filed on Oct. 20, 2022.

(30) Foreign Application Priority Data
Oct. 26, 2021 (JP) 2021-174776

(51) Int. Cl. H04W 76/40; H04W 68/02; H04W 72/30; H04W 76/20

(52) U.S. Cl. CPC H04W 76/40; H04W 68/02; H04W 72/30; H04W 76/20

(57) ABSTRACT

In a first aspect, a communication method is a method executed by a user equipment (UE 100) communicating with a first cell (cell #1) in a mobile communication system providing a multicast and broadcast service (MBS). The communication method includes transmitting, to the first cell, a message related to an MBS reception timing for the user equipment to perform MBS reception from a second cell (cell #2) belonging to a frequency different from a frequency to which the first cell belongs (S106).

### RELATED APPLICATIONS

The present application is a continuation based on PCT Application No. PCT/JP2022/039136, filed on Oct. 20, 2022, which claims the benefit of Japanese Patent Application No. 2021-174776 filed on Oct. 26, 2021. The content of which is incorporated by reference herein in their entirety.

### TECHNICAL FIELD

The present disclosure relates to a communication method used in a mobile communication system.

### BACKGROUND

In 3rd Generation Partnership Project (3GPP) standards, technical specifications of New Radio (NR) being radio access technology of the fifth generation (5G) have been defined. NR has features such as high speed, large capacity, high reliability, and low latency, in comparison to Long Term Evolution (LTE) being radio access technology of the fourth generation (4G). In 3GPP, there have been discussions for establishing technical specifications of multicast and broadcast services (MBS) of 5G/NR (for example, see Non-Patent Document 1).

### CITATION LIST

### Non-Patent Literature

Non-Patent Document 1: 3GPP Contribution: RP-201038, “WID revision: NR Multicast and Broadcast Services”

### SUMMARY

5G/NR multicast and broadcast services are desired to provide enhanced services compared to 4G/LTE multicast and broadcast services.

The present disclosure provides enabling of implementation of improved multicast and broadcast services.

In a first aspect, a communication method is a method executed by a user equipment communicating with a first cell in a mobile communication system providing a multicast and broadcast service (MBS). The communication method includes transmitting, to the first cell, a message related to an MBS reception timing for the user equipment to perform MBS reception from a second cell belonging to a frequency different from a frequency to which the first cell belongs.

In a second aspect, a communication method is a method executed by a network apparatus in a mobile communication system providing a multicast and broadcast service (MBS). The communication method includes receiving, from a user equipment via a first cell, a message related to an MBS reception timing for the user equipment to perform MBS reception from a second cell belonging to a frequency different from a frequency to which the first cell belongs.

In a third aspect, a communication method is a method executed by a user equipment communicating with a first cell in a mobile communication system providing a multicast and broadcast service (MBS). The communication method includes receiving, from the cell, broadcast information indicating an MBS session being provided by the cell in Receive-Only Mode (ROM) and/or Free-To-Air (FTA) and identifying the MBS session being provided by the cell in the ROM and/or the FTA, based on the broadcast information.

### BRIEF DESCRIPTION OF THE DRAWINGS

FIG. 1 is a diagram illustrating a configuration of a mobile communication system according to an embodiment.

FIG. 2 is a diagram illustrating a configuration of a user equipment (UE) according to an embodiment.

FIG. 3 is a diagram illustrating a configuration of a gNB (base station) according to an embodiment.

FIG. 4 is a diagram illustrating a configuration of a protocol stack of a radio interface of a user plane handling data.

FIG. 5 is a diagram illustrating a configuration of a protocol stack of a radio interface of a control plane handling signaling (control signal).

FIG. 6 is a diagram illustrating an overview of MBS traffic delivery according to an embodiment.

FIG. 7 is a diagram illustrating delivery modes according to an embodiment.

FIG. 8 is a diagram illustrating an example of internal processing related to MBS reception of a UE 100 according to an embodiment.

FIG. 9 is a diagram illustrating another example of internal processing related to MBS reception of the UE 100 according to an embodiment.

FIG. 10 is a diagram illustrating operation of the mobile communication system according to an embodiment.

FIG. 11 is a diagram illustrating a first operation example according to an embodiment.

FIG. 12 is a diagram illustrating a second operation example according to an embodiment.

FIG. 13 is a diagram illustrating a third operation example according to an embodiment.

FIG. 14 is a diagram illustrating a fourth operation example according to an embodiment.

### DESCRIPTION OF EMBODIMENTS

A mobile communication system according to an embodiment is described with reference to the drawings. In the description of the drawings, the same or similar parts are denoted by the same or similar reference signs.

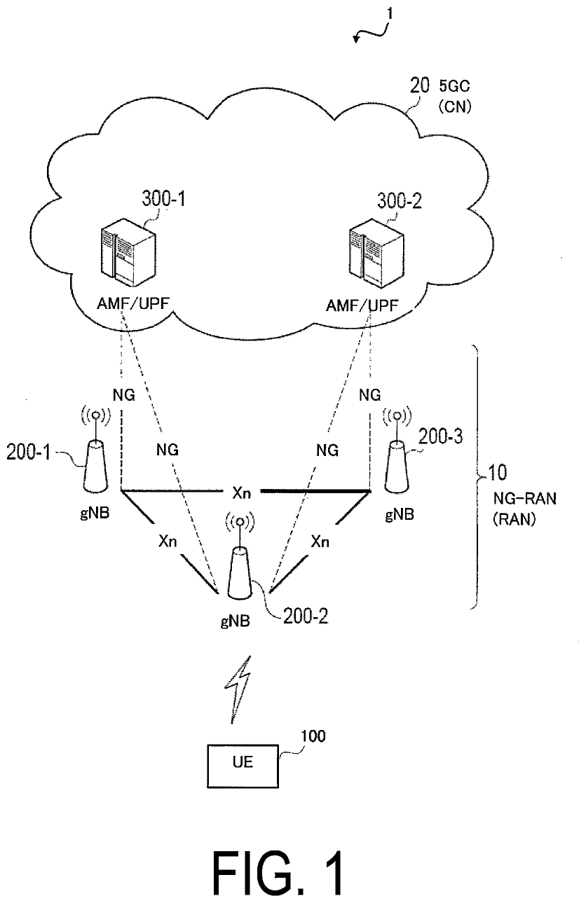

Configuration of Mobile Communication System FIG. 1 is a diagram illustrating a configuration of a mobile communication system according to an embodiment. The mobile communication system 1 complies with the 5th Generation System (5GS) of the 3GPP standard. The description below takes the 5GS as an example, but Long Term Evolution (LTE) system may be at least partially applied to the mobile communication system. A sixth generation (6G) system may be at least partially applied to the mobile communication system.

The mobile communication system 1 includes a User Equipment (UE) 100, a 5G radio access network (Next Generation Radio Access Network (NG-RAN)) 10, and a 5G Core Network (5GC) 20. The NG-RAN 10 may be hereinafter simply referred to as a RAN 10. The 5GC 20 may be simply referred to as a core network (CN) 20.

The UE 100 is a mobile wireless communication apparatus. The UE 100 may be any apparatus as long as the UE 100 is used by a user. Examples of the UE 100 include a mobile phone terminal (including a smartphone), a tablet terminal, a notebook PC, a communication module (including a communication card or a chipset), a sensor or an apparatus provided on a sensor, a vehicle or an apparatus provided on a vehicle (Vehicle UE), and a flying object or an apparatus provided on a flying object (Aerial UE).

The NG-RAN 10 includes base stations (referred to as “gNBs” in the 5G system) 200. The gNBs 200 are interconnected via an Xn interface which is an inter-base station interface. Each gNB 200 manages one or more cells. The gNB 200 performs wireless communication with the UE 100 that has established a connection to the cell of the gNB 200. The gNB 200 has a radio resource management (RRM) function, a function of routing user data (hereinafter simply referred to as “data”), a measurement control function for mobility control and scheduling, and the like. The “cell” is used as a term representing a minimum unit of a wireless communication area. The “cell” is also used as a term representing a function or a resource for performing wireless communication with the UE 100. One cell belongs to one carrier frequency (hereinafter simply referred to as one “frequency”).

Note that the gNB can be connected to an Evolved Packet Core (EPC) corresponding to a core network of LTE. An LTE base station can also be connected to the 5GC. The LTE base station and the gNB can be connected via an inter-base station interface.

The 5GC 20 includes an Access and Mobility Management Function (AMF) and a User Plane Function (UPF) 300. The AMF performs various types of mobility controls and the like for the UE 100. The AMF manages mobility of the UE 100 by communicating with the UE 100 by using Non-Access Stratum (NAS) signaling. The UPF controls data transfer. The AMF and UPF are connected to the gNB 200 via an NG interface which is an interface between a base station and the core network.

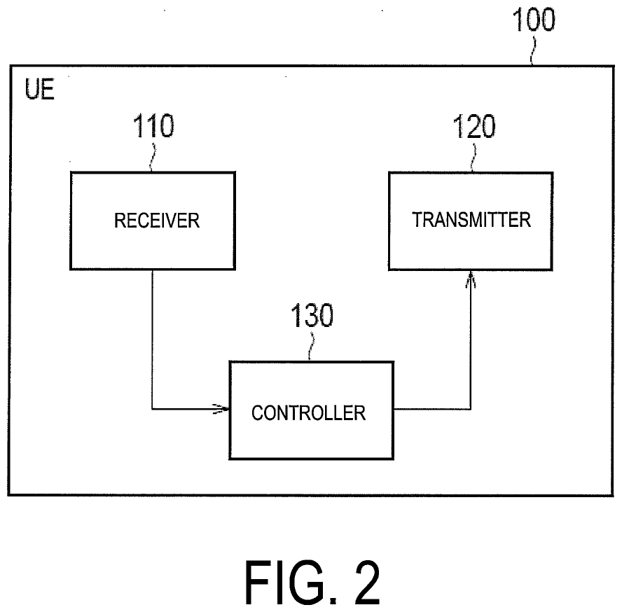

FIG. 2 is a diagram illustrating a configuration of the UE 100 (user equipment) to the embodiment. The UE 100 includes a receiver 110, a transmitter 120, and a controller 130. The receiver 110 and the transmitter 120 constitute a wireless communicator that performs wireless communication with the gNB 200.

The receiver 110 performs various types of reception under control of the controller 130. The receiver 110 includes an antenna and a reception device. The reception device converts a radio signal received through the antenna into a baseband signal (a reception signal) and outputs the resulting signal to the controller 130.

The transmitter 120 performs various types of transmission under control of the controller 130. The transmitter 120 includes an antenna and a transmission device. The transmission device converts a baseband signal (a transmission signal) output by the controller 130 into a radio signal and transmits the resulting signal through the antenna.

The controller 130 performs various types of control and processes in the ULE 100. Such processes include processes of respective layers to be described later. The controller 130 includes at least one processor and at least one memory. The memory stores a program to be executed by the processor and information to be used for processing by the processor. The processor may include a baseband processor and a Central Processing Unit (CPU). The baseband processor performs modulation and demodulation, coding and decoding, and the like of a baseband signal. The CPU executes the program stored in the memory to thereby perform various types of processing.

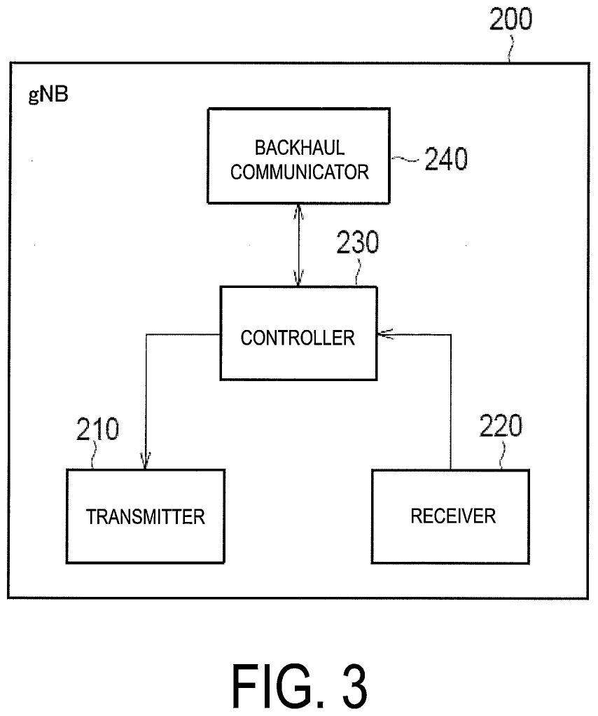

FIG. 3 is a diagram illustrating a configuration of the gNB 200 (base station) according to the embodiment. The gNB 200 includes a transmitter 210, a receiver 220, a controller 230, and a backhaul communicator 240. The transmitter 210 and the receiver 220 constitute a wireless communicator that performs wireless communication with the UE 100. The backhaul communicator 240 constitutes a network communicator that performs communication with the CN 20.

The transmitter 210 performs various types of transmission under control of the controller 230. The transmitter 210 includes an antenna and a transmission device. The transmission device converts a baseband signal (a transmission signal) output by the controller 230 into a radio signal and transmits the resulting signal through the antenna.

The receiver 220 performs various types of reception under control of the controller 230. The receiver 220 includes an antenna and a reception device. The reception device converts a radio signal received through the antenna into a baseband signal (a reception signal) and outputs the resulting signal to the controller 230.

The controller 230 performs various types of control and processes in the gNB 200. Such processes include processes of respective layers to be described later. The controller 230 includes at least one processor and at least one memory. The memory stores a program to be executed by the processor and information to be used for processing by the processor. The processor may include a baseband processor and a CPU. The baseband processor performs modulation and demodulation, coding and decoding, and the like of a baseband signal. The CPU executes the program stored in the memory to thereby perform various types of processing.

The backhaul communicator 240 is connected to a neighboring base station via an Xn interface which is an inter-base station interface. The backhaul communicator 240 is connected to the AMF/UPF 300 via a NG interface between a base station and the core network. Note that the gNB 200 may include a Central Unit (CU) and a Distributed Unit (DU) (i.e., functions are divided), and the two units may be connected via an F1 interface, which is a fronthaul interface.

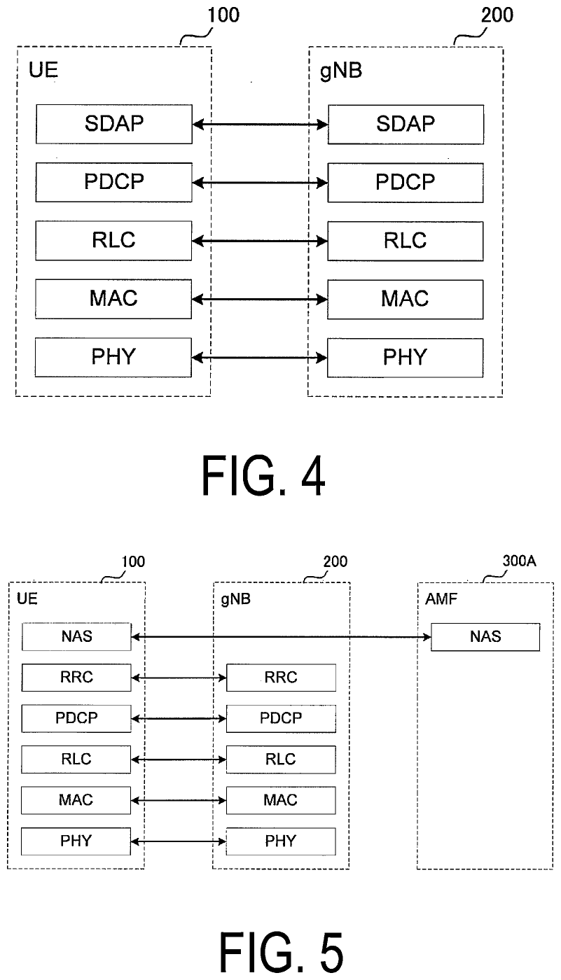

FIG. 4 is a diagram illustrating a configuration of a protocol stack of a radio interface of a user plane handling data.

A radio interface protocol of the user plane includes a physical (PHY) layer, a Medium Access Control (MAC) layer, a Radio Link Control (RLC) layer, a Packet Data Convergence Protocol (PDCP) layer, and a Service Data Adaptation Protocol (SDAP) layer.

The PHY layer performs coding and decoding, modulation and demodulation, antenna mapping and demapping, and resource mapping and demapping. Data and control information are transmitted between the PHY layer of the UE 100 and the PHY layer of the gNB 200 via a physical channel. Note that the PHY layer of the UE 100 receives downlink control information (DCI) transmitted from the gNB 200 over a physical downlink control channel (PDCCH). Specifically, the UE 100 blind decodes the PDCCH using a radio network temporary identifier (RNTI) and acquires successfully decoded DCI as DCI addressed to the ULE 100. The DCI transmitted from the gNB 200 is appended with CRC parity bits scrambled by the RNTI.

The MAC layer performs priority control of data, retransmission processing through hybrid ARQ (HARQ: Hybrid Automatic Repeat reQuest), a random access procedure, and the like. Data and control information are transmitted between the MAC layer of the UE 100 and the MAC layer of the gNB 200 via a transport channel. The MAC layer of the gNB 200 includes a scheduler. The scheduler determines transport formats (transport block sizes, Modulation and Coding Schemes (MCSs)) in the uplink and the downlink and resource blocks to be allocated to the UE 100.

The RLC layer transmits data to the RLC layer on the reception side by using functions of the MAC layer and the PHY layer. Data and control information are transmitted between the RLC layer of the UE 100 and the RLC layer of the gNB 200 via a logical channel.

The PDCP layer performs header compression/decompression, encryption/decryption, and the like.

The SDAP layer performs mapping between an IP flow as the unit of Quality of Service (QoS) control performed by a core network and a radio bearer as the unit of QoS control performed by an Access Stratum (AS). Note that, when the RAN is connected to the EPC, the SDAP need not be provided.

FIG. 5 is a diagram illustrating a configuration of a protocol stack of a radio interface of a control plane handling signaling (a control signal).

The protocol stack of the radio interface of the control plane includes a Radio Resource Control (RRC) layer and a Non-Access Stratum (NAS) layer instead of the SDAP layer illustrated in FIG. 4.

RRC signaling for various configurations is transmitted between the RRC layer of the UE 100 and the RRC layer of the gNB 200. The RRC layer controls a logical channel, a transport channel, and a physical channel depending on establishment, re-establishment, and release of a radio bearer. When a connection (RRC connection) between the RRC of the UE 100 and the RRC of the gNB 200 is present, the UE 100 is in an RRC connected state. When no connection (RRC connection) between the RRC of the UE 100 and the RRC of the gNB 200 is present, the UE 100 is in an RRC idle state. When the connection between the RRC of the UE 100 and the RRC of the gNB 200 is suspended, the UE 100 is in an RRC inactive state.

The NAS layer which is positioned upper than the RRC layer performs session management, mobility management, and the like. NAS signaling is transmitted between the NAS layer of the UE 100 and the NAS layer of an AMF 300A. Note that the UE 100 includes an application layer other than the protocol of the radio interface. A layer lower than the NAS layer is referred to as an AS layer.

### Overview of MBS

An overview of the MBS according to an embodiment will be provided. The MBS is a service in which the NG-RAN 10 can provide broadcast or multicast, i.e., Point To Multipoint (PTM) data transmission to the UE 100. Assumed use cases (service types) of the MBS include public safety communication, mission critical communication, Vehicle to Everything (V2X) communication, IPv4 or IPv6 multicast delivery, Internet Protocol TeleVision (IPTV), group communication, and software delivery.

A broadcast service provides a service to every UE 100 within a particular service area for an application not requiring highly reliable QoS. An MBS session used for the broadcast service is referred to as a broadcast session.

A multicast service provides a service not to every UE 100, but to a group of UEs 100 participating in the multicast service (multicast session). An MBS session used for the multicast service is referred to as a multicast session.

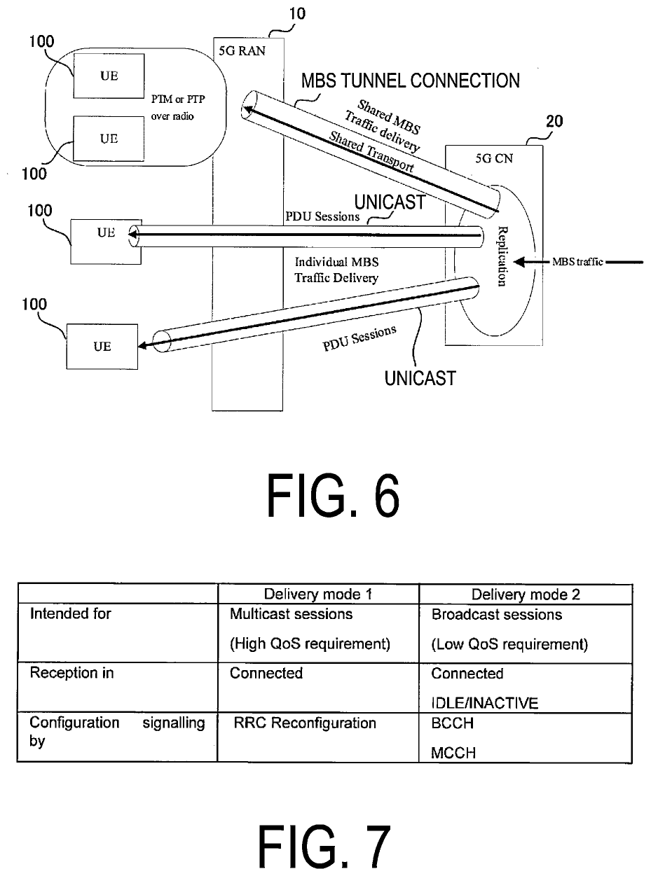

FIG. 6 is a diagram illustrating an overview of MBS traffic delivery according to an embodiment.

MBS traffic (MBS data) is delivered from a single data source (application service provider) to a plurality of UEs. The 5G CN (5GC) 20, which is a 5G core network, receives the MBS data from the application service provider and performs Replication of the MBS data to deliver the resultant.

From the perspective of the 5GC 20, two multicast delivery methods are possible: 5GC Shared MBS Traffic delivery and 5GC Individual MBS Traffic delivery.

In the 5GC individual MBS traffic delivery method, the 5GC 20 receives a single copy of MBS data packets and delivers individual copies of these MBS data packets to the individual UEs 100 via PDU sessions of the individual UEs 100. Thus, one PDU session for each UE 100 needs to be associated with a multicast session.

In the 5GC shared MBS traffic delivery method, the 5GC 20 receives a single copy of MBS data packets and delivers the single copy of the MBS packets to a RAN node (i.e., the gNB 200). The gNB 200 receives the MBS data packets via MBS tunnel connection, and delivers those to one or more UEs 100.

From the perspective of the RAN (5G RAN) 10, two delivery methods are possible for radio transmission of the MBS data in the 5GC shared MBS traffic delivery method: a Point-to-Point (PTP) delivery method and a Point-to-Multipoint (PTM) delivery method. PTP means unicast, and PTM means multicast and broadcast.

In the PTP delivery method, the gNB 200 wirelessly delivers the individual copies of the MBS data packets to the individual UEs 100. On the other hand, in the PTM delivery method, the gNB 200 wirelessly delivers the single copy of the MBS data packets to a group of the UEs 100. The gNB 200 can dynamically determine whether to use the PTM or PTP delivery method as a method for delivering the MBS data to one UE 100.

The PTP and PTM delivery methods are mainly related to the user plane. Modes for controlling the MBS data delivery include two delivery modes: a first delivery mode and a second delivery mode.

FIG. 7 is a diagram illustrating delivery modes according to an embodiment.

The first delivery mode (Delivery mode 1 (DM1)) is a delivery mode that can be used by the UE 100 in the RRC connected state, and is a delivery mode for high QoS requirements. The first delivery mode is used for multicast sessions among MBS sessions. Note that the first delivery mode may be used for broadcast sessions. The first delivery mode may be available to the UE 100 in the RRC idle state or the RRC inactive state.

MBS reception configuration in the first delivery mode is performed through UE-dedicated signaling. For example, the MBS reception configuration in the first delivery mode is performed through an RRC Reconfiguration message (or an RRC Release message), which is an RRC message unicast from the gNB 200 to the UE 100.

The MBS reception configuration includes MBS traffic channel configuration information (hereinafter referred to as “MTCH configuration information”) about configuration of an MBS traffic channel for transmitting MBS data. The MTCH configuration information includes MBS session information (including an MBS session identifier to be described later) relating to an MBS session and scheduling information of an MTCH corresponding to the MBS session. The scheduling information of the MTCH may include discontinuous reception (DRX) configuration of the MTCH. The discontinuous reception configuration may include at least one parameter of a timer value (On Duration Timer) for defining an on-period (On Duration: reception period), a timer value (Inactivity Timer) for extending the on-period, a scheduling interval or a DRX cycle (Scheduling Period, DRX Cycle), an offset value (Start Offset, DRX Cycle Offset) of a start subframe for scheduling or a DRX cycle, a start delay slot value (Slot Offset) of an on-period timer, a timer value (Retransmission Timer) for defining a maximum time until retransmission, and a timer value (HARQ RTT Timer) for defining a minimum interval until DL assignment of HARQ retransmission. Note that the MTCH (multicast traffic channel) is a type of logical channel. The MTCH is mapped to a downlink shared channel (Down Link-Shared CHannel (DL-SCH)) being a type of transport channel.

The second delivery mode (Delivery mode 2 (DM2)) is a delivery mode that can be used not only by the UE 100 in the RRC connected state, but also by the UE 100 in the RRC idle state or the RRC inactive state, and is a delivery mode for low QoS requirements. The second delivery mode is used for broadcast sessions among MBS sessions. However, the second delivery mode may also be applicable to multicast sessions.

An MBS reception configuration in the second delivery mode is performed through broadcast signaling. For example, the MBS reception configuration in the second delivery mode is performed using a logical channel transmitted from the gNB 200 to the UE 100 through broadcast, for example, a broadcast control channel (BCCH) and/or a multicast control channel (MCCH). The UE 100 can receive the BCCH and the MCCH, using a dedicated RNTI defined in technical specifications in advance, for example. The RNTI for BCCH reception may be an SI-RNTI, and the RNTI for MCCH reception may be an MCCH-RNTI.

In the second delivery mode, the UE 100 may receive the MBS data in the following three procedures. Firstly, the UE 100 receives MCCH configuration information on an MBS system information block (MBS SIB) transmitted from the gNB 200 on the BCCH. Secondly, the UE 100 receives the MCCH from the gNB 200, based on the MCCH configuration information. On the MCCH, MTCH configuration information is transmitted. The MCCH may include neighbor cell information indicating whether the MBS session being currently provided is also provided in a neighbor cell. Thirdly, the UE 100 receives the MTCH (MBS data), based on the MTCH configuration information. The MTCH configuration information and/or the MCCH configuration information may be hereinafter referred to as the MBS reception configuration. In the following embodiment, a case in which the UE 100 receives the MBS session delivered in the second delivery mode will be mainly described.

In the first delivery mode and the second delivery mode, the UE 100 may receive the MTCH, using a group RNTI (G-RNTI) assigned from the gNB 200. The G-RNTI corresponds to an RNTI for MTCH reception. The G-RNTI may be included in the MBS reception configuration (MTCH configuration information).

The network can provide different MBS services for different MBS sessions. The MBS session is identified by at least one selected from the group consisting of a Temporary Mobile Group Identity (TMGI), a source-specific IP multicast address (which consists of a source unicast IP address, such as an application function and an application server, and an IP multicast address indicating a destination address), a session identifier, and a G-RNTI. At least one selected from the group consisting of the TMGI, the source specific IP multicast address, and the session identifier is referred to as an MBS session identifier. The TMGI, the source-specific IP multicast address, the session identifier, and the G-RNTI are collectively referred to as MBS session information.

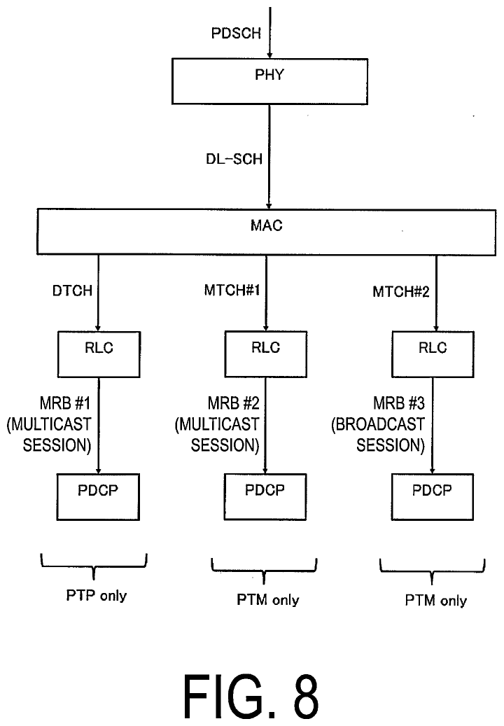

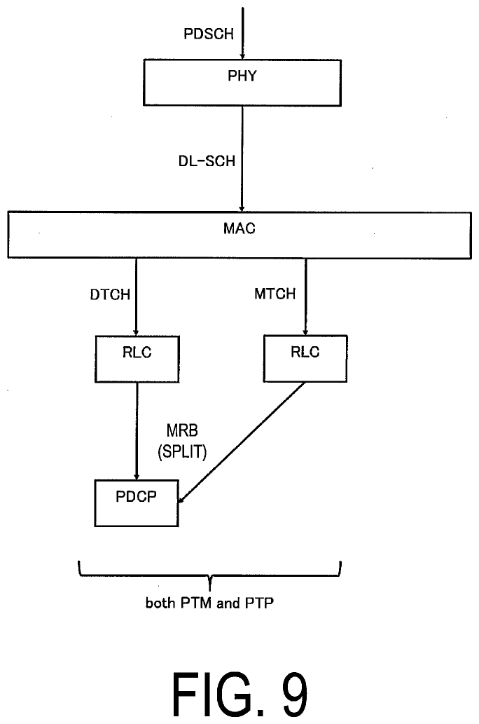

FIG. 8 is a diagram illustrating an example of internal processing related to MBS reception of the UE 100 according to an embodiment. FIG. 9 is a diagram illustrating another example of internal processing related to MBS reception of the UE 100 according to an embodiment.

One MBS radio bearer (MRB) is one radio bearer for transmitting a multicast session or a broadcast session. That is, the MRB may be associated with a multicast session, or the MRB may be associated with a broadcast session.

The MRB and its corresponding logical channel (for example, the MTCH) are configured from the gNB 200 to the UE 100, using RRC signaling. A procedure of configuring the MRB may be separate from a procedure of configuring a data radio bearer (DRB). In RRC signaling, one MRB can be configured with “PTM only”, “PTP only”, or “both PTM and PTP”. Such bearer types of the MRB can be changed using RRC signaling.

FIG. 8 illustrates an example in which MRB #1 is associated with a multicast session and a dedicated traffic channel (DTCH), MRB #2 is associated with a multicast session and MTCH #1, and MRB #3 is associated with a broadcast session and MTCH #2. That is, MRB #1 is an MRB of PTP only, MRB #2 is an MRB of PTM only, and MRB #3 is an MRB of PTM only. Note that the DTCH is scheduled using a cell RNTI (C-RNTI). The MTCH is scheduled using a G-RNTI.

The PHY layer of the ULE 100 processes user data (received data) received on the PDSCH, which is one of physical channels, and routes the processed user data to the downlink shared channel (DL-SCH), which is one of transport channels. The MAC layer (MAC entity) of the UE 100 processes the data received on the DL-SCH and routes the received data to a corresponding logical channel (corresponding RLC entity) based on a logical channel identifier (LCID) included in the header (MAC header) included in the received data.

FIG. 9 illustrates an example in which the DTCH and the MTCH are associated with the MRB associated with a multicast session. Specifically, one MRB is split into two legs, and one of the legs is associated with the DTCH and the other leg is associated with the MTCH. The two legs are connected in the PDCP layer (PDCP entity). That is, the MRB is an MRB of both PTM and PTP. Such an MRB may be referred to as a split MRB.

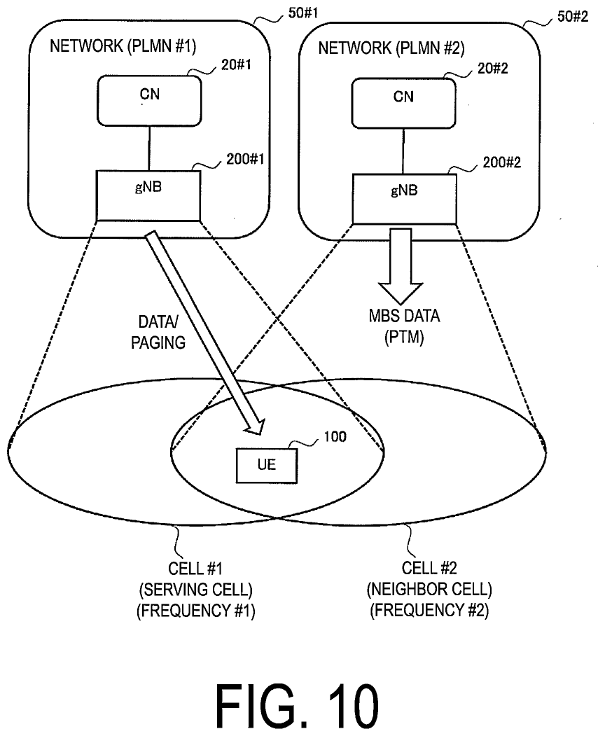

Operation of Mobile Communication System FIG. 10 is a diagram illustrating operation of the mobile communication system 1 according to an embodiment. Note that, in FIG. 10, a number denoted by “#” may mean an identifier or an index.

The UE 100 present in an overlapping area of cell #1 (first cell) and cell #2 (second cell) performs communication with cell #1. That is, cell #1 is a serving cell of the UE 100, and cell #2 is a neighbor cell of the serving cell. The UE 100 is in the RRC connected state, the RRC idle state, or the RRC inactive state in cell #1.

Cell #1 is operated in frequency (carrier frequency) #1, and cell #2 is operated in frequency (carrier frequency) #2. Such a relationship of frequencies is referred to as an inter-frequency. Cell #1 is managed by gNB 200 #1, and cell #2 is managed by gNB 200 #2. Cell #1 (gNB 200 #1) belongs to public land mobile network (PLMN) #1, and cell #2 (gNB 200 #2) belongs to PLMN #2. Such a relationship of PLMNs is referred to as an inter-PLMN. Network 50 #1 of PLMN #1 (first PLMN) includes gNB 200 #1 and CN 20 #1. Network 50 #2 of PLMN #2 (second PLMN) includes gNB 200 #2 and CN 20 #2. In general, one operator is assigned one PLMN identifier. Each cell broadcasts an identifier of the PLMN to which the cell belongs.

The UE 100 in the RRC connected state in cell #1 performs data communication with cell #1 (gNB 200 #1). Specifically, the UE 100 is assigned a C-RNTI from the gNB 200 #1 as an identifier of RRC connection. gNB 200 #1 assigns radio resources to the UE 100 via scheduling for the UE 100.

The UE 100 in the RRC idle state or the RRC inactive state in cell #1 performs paging monitoring from cell #1 (gNB 200 #1). Specifically, the UE 100 monitors paging transmitted from cell #1 (gNB 200 #1) at a paging reception timing (paging occasion) determined depending on a parameter of the UE 100, such as a UE identifier.

In the embodiment, cell #2 (gNB 200 #2) transmits MBS data belonging to the MBS session (for example, the broadcast session) in PTM. Specifically, cell #2 (gNB 200 #2) performs MBS transmission in the second delivery mode. Cell #2 (gNB 200 #2) may provide the MBS session in Receive-Only Mode (ROM) and/or Free-To-Air (FTA).

ROM is a mode in which MBS reception is available for the UE 100 that does not include a Subscriber Identity Module (SIM) and/or that is not subscribed to services with an operator (PLMN). For example, the UE 100 may be an apparatus (for example, a television receiver) that has a downlink reception function but does not have an uplink transmission function. FTA is an application (service) for enabling free broadcast contents broadcasting. FTA may be one aspect of ROM. The MBS session provided in FTA may be provided to be available for all users who are not mobile subscribers. When ROM and FTA are not particularly distinguished, ROM and FTA are hereinafter referred to as ROM/FTA.

For example, the UE 100 belongs to PLMN #1. The UE 100 may have a SIM of PLMN #1 and/or may be subscribed to services with PLMN #1. It is assumed that the UE 100 is interested in receiving the MBS session provided by PLMN #2, that is, cell #2 (gNB 200 #2). It is assumed that the MBS session provided by cell #2 (gNB 200 #2) in ROM/FTA can also be received by the UE 100 belonging to PLMN #1. Note that it may be assumed that the MBS session provided by cell #2 (gNB 200 #2) in PTM, not only in ROM/FTA, can also be received by the UE 100 belonging to PLMN #1. The following mainly assumes a scenario in which the UE 100 belonging to PLMN #1 receives the MBS session provided by cell #2 (gNB 200 #2) in ROM/FTA.

Since the UE 100 communicating with cell #1 (gNB 200 #1) has a limited number of its reception devices, a problem exists in performing MBS reception from cell #2 (gNB 200 #2) while maintaining a communicated state with cell #1 (gNB 200 #1).

Specifically, the UE 100 has a problem in performing MBS reception from cell #2 (frequency #2) of the inter-frequency while maintaining cell #1 (frequency #1) as the serving cell (serving frequency) of the UE 100. For example, the UE 100 including only one reception device cannot perform MBS reception from cell #2 (frequency #2) while performing reception from cell #1 (frequency #1). Even when the UE 100 includes a plurality of reception devices, the UE 100 cannot perform MBS reception from cell #2 (frequency #2) in a scenario (for example, carrier aggregation) in which the plurality of reception devices are all in use for communication with network 50 #1.

Here, if gNB 200 #1 (network 50 #1) recognizes an MBS interest of the UE 100 and an MBS transmission configuration (an MBS timing, in particular) of gNB 200 #2, communication, for example, data communication or paging transmission, with the UE 100 can be performed in a manner of avoiding the timing. Thus, the UE 100 can perform MBS reception from cell #2 (gNB 200 #2) at the timing. However, in a scenario of the inter-PLMN, gNB 200 #1 and gNB 200 #2 belong to different PLMNs, and thus a problem exists in sharing MBS transmission configurations through network coordination.

The UE 100 according to an embodiment transmits, to cell #1, a message related to the MBS reception timing for the UE 100 to perform MBS reception from cell #2. The message may be an RRC message transmitted from the UE 100 to cell #1 (gNB 200 #1). The RRC message may be a UE Assistance Information message. The message may be an MBS Interest Indication message. Alternatively, the message may be a NAS message transmitted from the UE 100 to CN 20 #1 (AMF 300A) via cell #1 (gNB 200 #1). The NAS message may be a CONFIGURATION UPDATE COMPLETE message, a REGISTRATION REQUEST message, or a SERVICE REQUEST message.

A network apparatus included in network 50 #1, for example, gNB 200 #1 or CN 20 #1 (AMF 300A), receives the message from the UE 100 via cell #1. Thus, the network apparatus is enabled to perform communication, for example, data communication or paging transmission, with the UE 100 in a manner of avoiding the MBS reception timing for the UE 100 to perform MBS reception from cell #2.

### (1) First Operation Example

In a first operation example, gNB 200 #1 that has received the message (for example, the RRC message) from the UE 100 transmits, to the UE 100 via cell #1, an MBS gap configuration indicating a configuration of a gap for the MBS for suspending communication with cell #1 to perform MBS reception from cell #2. After transmission of the message, the UE 100 receives, from cell #1, the MBS gap configuration indicating the configuration of the gap for the MBS for suspending communication with cell #1 to perform MBS reception from cell #2.

The UE 100 in the RRC connected state in cell #1 suspends data communication with cell #1 and performs MBS reception from cell #2 in the gap for the MBS, based on the MBS gap configuration from gNB 200 #1. Thus, the UE 100 is enabled to perform MBS reception from cell #2 while maintaining the RRC connected state with cell #1 (gNB 200 #1).

In the first operation example, the UE 100 generates requested gap information indicating the configuration of the gap for the MBS requested by the UE 100, based on a configuration of the MCCH of cell #2 and/or a configuration of the MTCH of cell #2. The UE 100 transmits a message including the requested gap information to cell #1 (gNB 200 #1). Cell #1 (gNB 200 #1) receives the message including the requested gap information, and transmits the MBS gap configuration based on the requested gap information to the UE 100. Thus, the gap for the MBS can be appropriately configured for the UE 100.

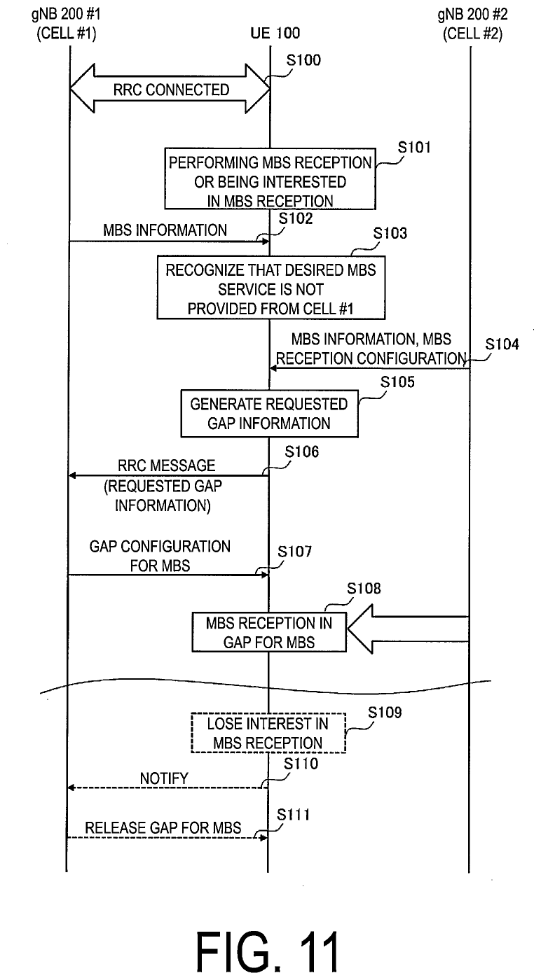

FIG. 11 is a diagram illustrating the first operation example. In the following description, cell #1 (gNB 200 #1) may be interpreted as network 50 #1 (PLMN #1). Cell #2 (gNB 200 #2) may be interpreted as network 50 #2 (PLMN #2).

In Step S100, the UE 100 is in the RRC connected state in cell #1.

In Step S101, the UE 100 is performing MBS reception or is interested in the MBS reception. Here, an example is assumed in which the UE 100 is performing reception of the MBS session (for example, the broadcast session) provided in ROM/FTA or is interested in the reception. Here, “performing MBS reception” may be a state in which the MBS session provided from cell #2 in ROM/FTA is being received.

Note that the UE 100 may acquire higher layer information indicating a correspondence between the MBS session (MBS session identifier) provided in ROM/FTA and a frequency (frequency identifier) in advance. The higher layer information may further include information indicating start time of the MBS session and/or information indicating an MBS service area in which the MBS session is provided. The UE 100 may recognize a desired MBS frequency for providing the MBS session (desired MBS session), based on the higher layer information. Such higher layer information may be provided as User Service Description (USD) or may be provided by a NAS message (for example, a REGISTRATION ACCEPT message, a CONFIGURATION UPDATE COMMAND message, or a PDU SESSION ESTABLISHMENT ACCEPT message).

In Step S102, the UE 100 receives, from cell #1 (gNB 200 #1), MBS information indicating the correspondence between the MBS session provided by network 50 #1 (PLMN #1) and the frequency and/or the MBS session provided by cell #1 in ROM/FTA. Such MBS information may be information broadcast in the SIB or the MCCH of cell #1.

For example, the MBS information indicating the correspondence between the MBS session provided by network 50 #1 and the frequency may include a plurality of sets of the MBS session identifier and the frequency identifier. Based on such MBS information, the UE 100 can recognize which MBS session is provided in which frequency.

The MBS information indicating the MBS session provided by cell #1 in ROM/FTA may include an MBS session identifier list of the MBS sessions provided by cell #1 in ROM/FTA. Based on such MBS information, the UE 100 can recognize which MBS session is provided by cell #1 in ROM/FTA.

In Step S103, based on the MBS information received in Step S102, the UE 100 recognizes that a desired MBS session to which ROM/FTA is applied is not provided from network 50 #1 (PLMN #1).

For example, based on the MBS information indicating the correspondence between the MBS session provided by network 50 #1 and the frequency, when a desired MBS session and/or a desired MBS frequency is not indicated by the MBS information, the UE 100 may recognize that the desired MBS session is not provided from network 50 #1 (PLMN #1). When the desired MBS frequency for providing the desired MBS session to which ROM/FTA is applied is not indicated by the MBS information, the UE 100 may recognize that the desired MBS session and/or the desired MBS frequency may be provided from another network, that is, network 50 #2 (PLMN #2).

Alternatively, based on the MBS information indicating the MBS session provided by cell #1 in ROM/FTA, when the desired MBS session is not indicated by the MBS information, the UE 100 may recognize that the desired MBS session and/or the desired MBS frequency may be provided from another network, that is, network 50 #1 (PLMN #1), without the desired MBS session being provided from network 50 #1 (PLMN #1).

In Step S104, the UE 100 may receive, from cell #2 (gNB 200 #2), the MBS information indicating the correspondence between the MBS session provided by network 50 #2 (PLMN #2) and the frequency and/or the MBS session provided by cell #2 in ROM/FTA. Such MBS information may be information broadcast in the SIB or the MCCH of cell #2. Based on the MBS information, the UE 100 may confirm that the desired MBS session and/or the desired MBS frequency is provided from cell #2.

In Step S104, the UE 100 receives the MBS reception configuration in cell #2 from cell #2. Such MBS reception configuration includes the MCCH configuration information broadcast in the SIB (MBS SIB) of cell #2 and/or the MTCH configuration information broadcast in the MCCH of cell #2. For example, after receiving the MCCH configuration information using the MBS SIB transmitted on the BCCH from cell #2, the UE 100 receives the MCCH from the gNB 200 based on the MCCH configuration information and thereby receives the MTCH configuration information.

The MCCH configuration information includes scheduling information of the MCCH, that is, information indicating an MCCH reception timing (MCCH reception occasion). The MTCH configuration information includes scheduling information of the MTCH, that is, information indicating an MTCH reception timing (MTCH reception occasion). Such an MCCH reception timing (MCCH reception occasion) and/or an MTCH reception timing (MTCH reception occasion) corresponds to the MBS reception timing for the UE 100 to perform MBS reception from cell #2. Specifically, the MTCH reception timing constituting the MBS reception timing may be an MTCH reception timing associated with the desired MBS session out of MTCH reception timings indicated for each MBS session via the MCCH.

In Step S105, based on the MBS reception timing recognized in Step S104, the UE 100 determines a gap pattern configuration of the gap for the MBS for suspending data communication with cell #1, and generates requested gap information indicating the determined gap pattern configuration. A gap pattern refers to a pattern of periodically repeated gaps for the MBS. The requested gap information includes information indicating a start timing of the gap pattern (a system frame number, a subframe number, and/or the like) and information indicating the gap pattern, for example, a bitmap for each subframe or a period (cycle length) of the gap for the MBS. The requested gap information may include information indicating duration of each gap for the MBS. Note that the UE 100 determines a requested gap pattern in accordance with a timing (a system frame number or the like) of cell #1. Here, when the UE 100 determines the requested gap pattern, the UE 100 may add, to the requested gap pattern, a time (margin) necessary to change the frequency of the reception device of the UE 100 and/or a measurement time for establishing synchronization with cell #2.

In Step S106, the UE 100 transmits an RRC message including the requested gap information generated in Step S105 to cell #1 (gNB 200 #1). The UE 100 may further include, in the RRC message, a desired MBS session identifier (for example, a TMGI) and/or a desired MBS frequency identifier associated with the requested gap information.

In Step S107, cell #1 (gNB 200 #1) generates the MBS gap configuration indicating the configuration of the gap (gap pattern) for the MBS, based on the requested gap information in the RRC message received from the UE 100 in Step S106, and transmits the MBS gap configuration to the UE 100. For example, cell #1 (gNB 200 #1) transmits an RRC reconfiguration message including the MBS gap configuration to the UE 100. A type of information included in the MBS gap configuration may be the same as and/or similar to the type of information included in the requested gap information. Cell #1 (gNB 200 #1) may further include, in the RRC reconfiguration message, a cell identifier and/or a cell group identifier associated with the MBS gap configuration. Cell #1 (gNB 200 #1) may include, in the RRC reconfiguration message, a plurality of sets of the MBS gap configuration and the cell identifier and/or the cell group identifier.

In Step S108, the UE 100 suspends data communication with cell #1 (gNB 200 #1) and performs MBS reception of the desired MBS session from cell #2 (gNB 200 #2) in the gap for the MBS indicated by the MBS gap configuration received from cell #1 (gNB 200 #1) in Step S107. Specifically, the UE 100 changes (tunes) a reception frequency of the reception device from frequency #1 to frequency #2, and then performs MBS reception, that is, MTCH reception (and MCCH reception), from cell #2 (gNB 200 #2). Cell #1 (gNB 200 #1) does not assign radio resources to the UE 100 in the configured MBS reception gap.

Here, when the UE 100 uses a plurality of serving cells (or a plurality of cell groups) for communication with network 50 #1 (that is, in carrier aggregation or dual connectivity), the UE 100 may identify the serving cell (and/or the cell group) to which the MBS gap configuration is applied based on the cell identifier and/or the cell group identifier in the RRC reconfiguration message, and perform MBS reception from cell #2 (gNB 200 #2) using the reception device assigned for the identified serving cell (and/or cell group). Note that the reception device assigned for a serving cell (and/or a cell group) other than the identified serving cell (and/or cell group) may continue reception from the serving cell while maintaining the frequency/serving cell as it is.

When the UE 100 loses interest in MBS reception from cell #2 (gNB 200 #2) (Step S109), the UE 100 may notify cell #1 (gNB 200 #1) (Step S110). The UE 100 may transmit the notification in an RRC message, for example, a UE Assistance Information message or an MBS Interest Indication message. The notification may be a request to release the gap. The notification may be an MBS reception gap request not including the requested gap pattern. Based on the notification, cell #1 (gNB 200 #1) may remove (release) the MBS reception gap configuration from the UE 100 (Step S111).

### (2) Second Operation Example

The first operation example described above describes an example in which the UE 100 determines the requested gap pattern. However, the UE 100 may transmit an RRC message including configuration information indicating the configuration of the MCCH of cell #2 and/or the configuration of the MTCH of cell #2 to cell #1 (gNB 200 #1) without determining the requested gap pattern. That is, the UE 100 may forward the MBS reception configuration received from cell #2 to cell #1 (gNB 200 #1). Cell #1 (gNB 200 #1) receives the RRC message from the UE 100, determines the gap pattern based on the MBS reception configuration in the RRC message, and configures the gap pattern for the UE 100.

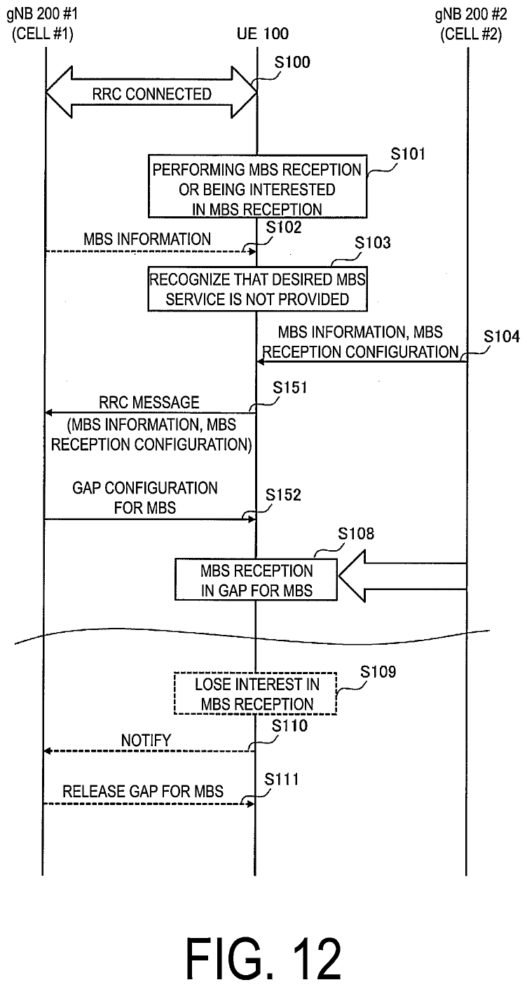

FIG. 12 is a diagram illustrating the second operation example. Here, differences from the first operation example described above will be described, and overlapping description will be omitted.

In Step S151, the UE 100 transmits an RRC message including at least a part of the MBS reception information received from cell #2 in Step S104 to cell #1 (gNB 200 #1). For example, the UE 100 includes the MCCH configuration information and/or the MTCH configuration information of cell #2 in the RRC message. The UE 100 may include only the MTCH configuration information (MTCH scheduling information) associated with the desired MBS session out of the MTCH configuration information (MTCH scheduling information) for each MBS session in the RRC message. When a difference exists between radio frame timings of cell #1 and cell #2, the UE 100 may further include information indicating an amount (offset) of the difference in the RRC message. The UE 100 may further include the desired MBS session identifier (for example, the TMGI) and/or the desired MBS frequency identifier in the RRC message.

In Step S152, based on the MBS reception configuration in the RRC message received from the UE 100 in Step S106, cell #1 (gNB 200 #1) determines the gap pattern in the same manner as and/or a similar manner to Step S105 described above. Then, cell #1 (gNB 200 #1) transmits the MBS gap configuration indicating the configuration of the gap (gap pattern) for the MBS to the UE 100. For example, cell #1 (gNB 200 #1) transmits an RRC reconfiguration message including the MBS gap configuration to the UE 100. In the same manner as and/or a similar manner to the first operation example described above, cell #1 (gNB 200 #1) may further include the cell identifier and/or the cell group identifier associated with the MBS gap configuration in the RRC reconfiguration message.

### (3) Third Operation Example

The first operation example and the second operation example described above describe an example in which the gap for the MBS to be used by the UE 100 in the RRC connected state is configured from cell #1 (gNB 200 #1) to the UE 100.

When the UE 100 is in the RRC idle state, the UE 100 needs to monitor paging transmitted from network 50 #1, specifically, AMF 300A #1 included in CN 20 #1, via cell #1 (gNB 200 #1). When such a paging reception timing (paging reception occasion) and an MBS reception timing (MBS reception occasion) from cell #2 at least partially overlap, the UE 100 has a problem in appropriately performing MBS reception from cell #2.

In a third operation example, the UE 100 transmits a NAS message related to the MBS reception timing for the UE 100 to perform MBS reception from cell #2 to AMF 300A #1 via cell #1 (gNB 200 #1). Here, the UE 100 may transmit a NAS message including request information for requesting a change of the paging reception timing to AMF 300A #1. The request information may include the requested gap information as in the first operation example described above. The request information may include the MBS reception configuration as in the second operation example described above.

Based on the received request information, AMF 300A #1 transmits a paging reception configuration for configuring the paging reception timing in a manner of avoiding the MBS reception timing in cell #2 to the UE 100 via cell #1 (gNB 200 #1). That is, AMF 300A #1 adjusts the paging reception timing of the UE 100 in a manner of avoiding the MBS reception timing in cell #2. Note that, in the present operation example, AMF 300A #1 corresponds to a paging management apparatus.

Based on the paging reception configuration from AMF 300A #1, the UE 100 in the RRC idle state monitors the paging from cell #1 at the adjusted paging reception timing, and performs MBS reception from cell #2 at a timing different from the paging reception timing. Thus, the UE 100 can perform MBS reception from cell #2 while maintaining the RRC idle state in cell #1.

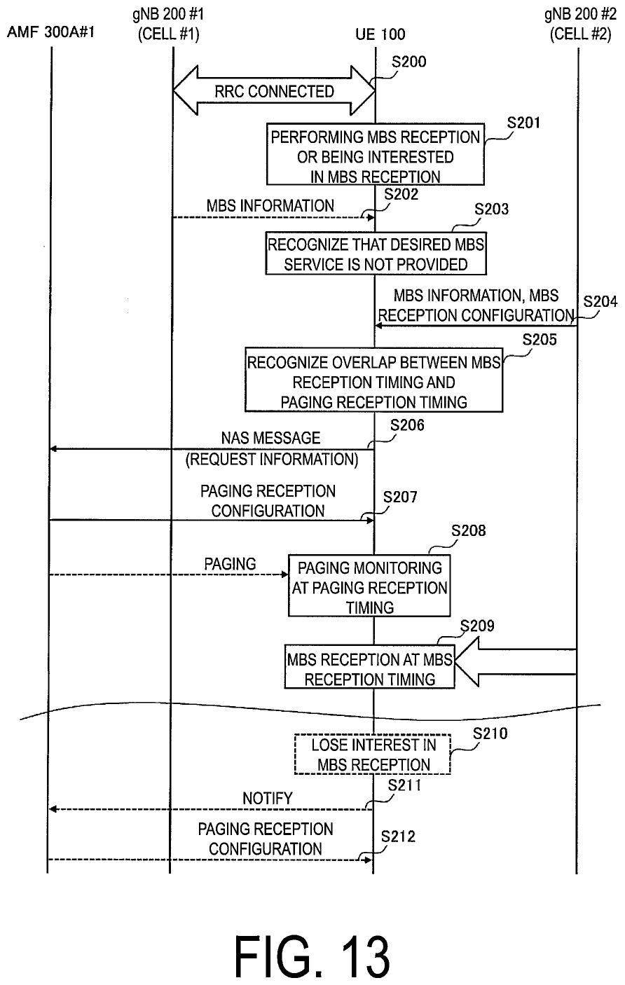

FIG. 13 is a diagram illustrating the third operation example. Here, differences from the first operation example and the second operation example described above will be described, and overlapping description will be omitted.

In Step S200, the UE 100 is in the RRC idle state in cell #1. The UE 100 in the RRC idle state in cell #1 performs paging monitoring from cell #1 (gNB 200 #1). Specifically, the UE 100 monitors paging transmitted from cell #1 (gNB 200 #1) at a paging reception timing (paging occasion) determined depending on a parameter of the UE 100, such as a UE identifier.

In Step S201, the UE 100 is performing MBS reception or is interested in the MBS reception. Here, an example is assumed in which the UE 100 is performing reception of the MBS session (for example, the broadcast session) provided in ROM/FTA or is interested in the reception.

In Step S202, the UE 100 receives, from cell #1 (gNB 200 #1), MBS information indicating the correspondence between the MBS session provided by network 50 #1 (PLMN #1) and the frequency and/or the MBS session provided by cell #1 in ROM/FTA. Such MBS information may be information broadcast in the SIB or the MCCH of cell #1.

In Step S203, based on the MBS information received in Step S202, the UE 100 recognizes that a desired MBS session to which ROM/FTA is applied is not provided from network 50 #1 (PLMN #1).

In Step S204, the UE 100 may receive, from cell #2 (gNB 200 #2), the MBS information indicating the correspondence between the MBS session provided by network 50 #2 (PLMN #2) and the frequency and/or the MBS session provided by cell #2 in ROM/FTA. Based on the MBS information, the UE 100 may confirm that the desired MBS session and/or the desired MBS frequency is provided from cell #2.

In Step S204, the UE 100 receives the MBS reception configuration in cell #2 from cell #2, and recognizes the MBS reception timing in cell #2.

In Step S205, the UE 100 recognizes that the MBS reception timing in cell #2 overlaps (collides with) the paging reception timing in cell #1.

In Step S206, the UE 100 transmits a NAS message including the request information for requesting a change of the paging reception timing to AMF 300A #1 via cell #1 (gNB 200 #1). Such request information may be information for requesting a change of the UE identifier (for example, a 5G-S-TMSI), or may include an alternative UE identifier (that is, a desired UE identifier) or an offset value of the UE identifier (that is, an offset value to be added to the UE identifier in calculation of the paging reception timing, which may be a desired offset value). Alternatively, it may be information indicating a desired paging reception timing (paging occasion (PO)). Here, the UE 100 may transition from the RRC idle state to the RRC connected state and then transmit the NAS message.

In Step S207, based on the received request information, AMF 300A #1 transmits the paging reception configuration for configuring the paging reception timing in a manner of avoiding the MBS reception timing in cell #2 to the UE 100 via cell #1 (gNB 200 #1). Such a paging reception configuration may include a parameter for determining an adjusted paging reception timing, for example, the UE identifier (5G-S-TMSI). Such a paging reception configuration may include an offset value to be added to the 5G-S-TMSI. When the UE 100 receives the paging reception configuration, the UE 100 may transition to the RRC idle state.

Based on the paging reception configuration from AMF 300A #1, the UE 100 in the RRC idle state monitors the paging from cell #1 at the adjusted paging reception timing (Step S208), and performs MBS reception from cell #2 at a timing different from the paging reception timing (Step S209). Note that the order of Steps S208 and S209 may be inverted.

When the UE 100 loses interest in MBS reception from cell #2 (gNB 200 #2) (Step S210), the UE 100 may notify AMF 300A #1 (Step S211). Here, the UE 100 may transition from the RRC idle state to the RRC connected state and then perform the notification. The notification may be a request to release adjustment of the paging occasion. The notification may be an adjustment request not including the requested gap pattern. Based on the notification, AMF 300A #1 may restore the paging reception configuration in the UE 100 (Step S212).

Note that the present operation example describes an example in which the NAS message is transmitted from the UE 100 to AMF 300A #1 in Step S206. However, an RRC message including the request information may be transmitted from the UE 100 to cell #1 (gNB 200 #1) in Step S206. Cell #1 (gNB 200 #1) may forward the received request information to AMF 300A #1 on an NG interface.

### (4) Fourth Operation Example

The third operation example described above describes an example in which AMF 300A #1 adjusts the paging reception timing of the UE 100 in the RRC idle state. A fourth operation example will describe an example in which gNB 200 #1 adjusts the paging reception timing of the UE 100 in the RRC inactive state. Instead of AMF 300A #1, gNB 200 #1 manages paging for the UE 100 in the RRC inactive state. Such paging may be referred to as RAN paging. In the present operation example, gNB 200 #1 corresponds to a paging management apparatus.

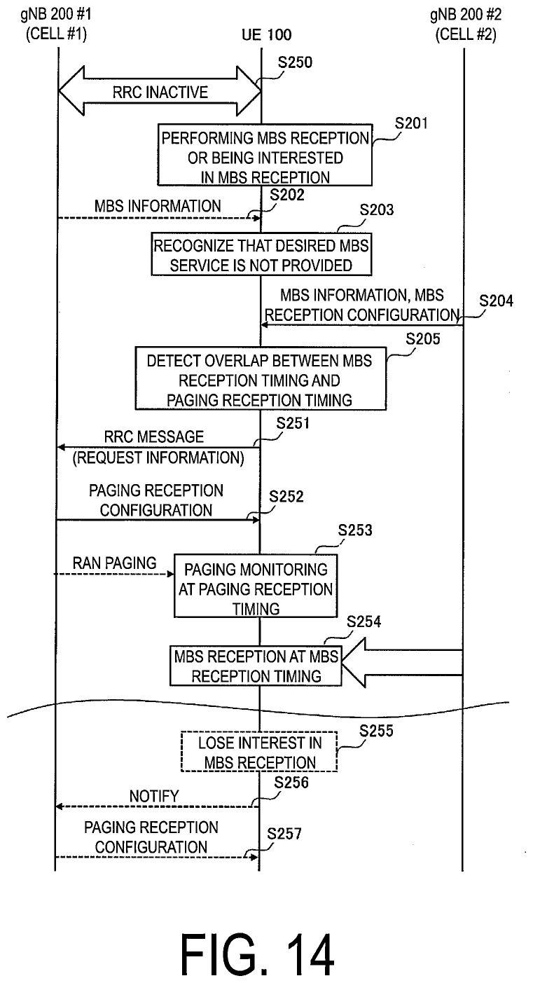

FIG. 14 is a diagram illustrating the fourth operation example. Here, differences from the third operation example described above will be described, and overlapping description will be omitted.

In Step S250, the UE 100 is in the RRC inactive state in cell #1. The UE 100 in the RRC inactive state in cell #1 performs paging monitoring from cell #1 (gNB 200 #1). Specifically, the UE 100 monitors paging transmitted from cell #1 (gNB 200 #1) at a paging reception timing (paging occasion) determined depending on a parameter of the UE 100, such as a UE identifier.

In Step S251, the UE 100 transmits an RRC message including the request information for requesting a change of the paging reception timing to cell #1 (gNB 200 #1). Here, the UE 100 may transition from the RRC inactive state to the RRC connected state and then transmit the RRC message.

In Step S252, based on the received request information, cell #1 (gNB 200 #1) transmits the paging reception configuration for configuring the paging reception timing in a manner of avoiding the MBS reception timing in cell #2 to the UE 100. Such a paging reception configuration may include a parameter for determining an adjusted paging reception timing, for example, the UE identifier (5G-S-TMSI). Such a paging reception configuration may include an offset value to be added to the 5G-S-TMSI. When the UE 100 receives the paging reception configuration, the UE 100 may transition to the RRC inactive state. Note that, in the same manner as and/or a similar manner to Steps S206 and S207 of the third operation example, Steps S251 and S252 may be performed between AMF 300A #1 and the UE 100. In this case, AMF 300A #1 or the UE 100 may notify gNB 200 #1 of the parameter for determining the adjusted paging reception timing, using an NG-AP message or an RRC message.

Based on the paging reception configuration from cell #1 (gNB 200 #1), the UE 100 in the RRC inactive state monitors the paging from cell #1 at the adjusted paging reception timing (Step S253), and performs MBS reception from cell #2 at a timing different from the paging reception timing (Step S254). Note that the order of Steps S253 and S254 may be inverted.

When the UE 100 loses interest in MBS reception from cell #2 (gNB 200 #2) (Step S255), the UE 100 may notify cell #1 (gNB 200 #1) (Step S256). Here, the UE 100 may transition from the RRC inactive state to the RRC connected state and then perform the notification. The notification may be a request to release adjustment of the paging occasion. The notification may be an adjustment request not including the requested gap pattern. Based on the notification, cell #1 (gNB 200 #1) may restore the paging reception configuration in the UE 100 (Step S257).

### OTHER EMBODIMENTS

The embodiment described above describes an example in which the UE 100 receives broadcast information (MBS information) indicating the MBS session being provided by a cell in ROM/FTA from the cell, using the SIB or the MCCH. That is, the cell (gNB 200) broadcasts the MBS information indicating the MBS session being provided by the cell in ROM/FTA. Based on the broadcast information (MBS information), the UE 100 identifies the MBS session being provided by the cell in ROM/FTA.

Such an operation may be used for a cell reselection procedure performed by the UE 100 in the RRC idle state or the RRC inactive state. For example, when the UE 100 in the RRC idle state or the RRC inactive state is performing reception of a desired MBS session to which ROM/FTA is applied or is interested in the reception, the UE 100 preferentially reselects a cell providing the desired MBS session, and camps on the cell. Here, the UE 100 may receive the MBS information broadcast from the cell, and determine whether the cell provides the desired MBS session. When the cell is determined to provide the desired MBS session, the UE 100 may determine a frequency to which the cell belongs as the highest priority of cell reselection.

The embodiment described above describes an example in which cell #1 is a cell belonging to PLMN #1 and cell #2 is a cell belonging to PLMN #2. However, such a scenario of the inter-PLMN is not restrictive, and cell #1 and cell #2 may belong to the same PLMN. Although the scenario of the inter-frequency is assumed, a scenario of an intra-frequency, that is, a scenario in which cell #1 and cell #2 are operated in the same frequency, may be employed. The embodiment described above describes an example of reception of the MBS session in which MBS reception from cell #2 (gNB 200 #2) is provided in ROM/FTA. However, the MBS session provided by cell #2 (gNB 200 #2) need not necessarily be in ROM/FTA. The MBS session provided by cell #2 (gNB 200 #2) may be a broadcast session or may be a multicast session.

The operation flows described above can be separately and independently implemented, and also be implemented in combination of two or more of the operation flows. For example, some steps of one operation flow may be added to another operation flow or some steps of one operation flow may be replaced with some steps of another operation flow.

In the embodiments and examples described above, an example in which the base station is an NR base station (i.e., a gNB) is described; however, the base station may be an LTE base station (i.e., an eNB) or a 6G base station. The base station may be a relay node such as an Integrated Access and Backhaul (IAB) node. The base station may be a DU of the IAB node. The user equipment may be a Mobile Termination (MT) of the JAB node.

A program causing a computer to execute each of the processes performed by the UE 100 or the gNB 200 may be provided. The program may be recorded in a computer readable medium. Use of the computer readable medium enables the program to be installed on a computer. Here, the computer readable medium on which the program is recorded may be a non-transitory recording medium. The non-transitory recording medium is not particularly limited, and may be, for example, a recording medium such as a CD-ROM or a DVD-ROM. Circuits for executing processing performed by the UE 100 or the gNB 200 may be integrated, and at least a part of the UE 100 or the gNB 200 may be implemented as a semiconductor integrated circuit (chipset, system on a chip (SoC)).

Embodiments have been described above in detail with reference to the drawings, but specific configurations are not limited to those described above, and various design variation can be made without departing from the gist of the present disclosure.

The phrases “based on” and “depending on” used in the present disclosure do not mean “based only on” and “only depending on,” unless specifically stated otherwise. The phrase “based on” means both “based only on” and “based at least in part on”. Similarly, the phrase “depending on” means both “only depending on” and “at least partially depending on”. “Obtain” or “acquire” may mean to obtain information from stored information, may mean to obtain information from information received from another node, or may mean to obtain information by generating the information. The terms “include”, “comprise” and variations thereof do not mean “include only items stated” but instead mean “may include only items stated” or “may include not only the items stated but also other items”. The term “or” used in the present disclosure is not intended to be “exclusive or”. Further, any references to elements using designations such as “first” and “second” as used in the present disclosure do not generally limit the quantity or order of those elements. These designations may be used herein as a convenient method of distinguishing between two or more elements. Thus, a reference to first and second elements does not mean that only two elements may be employed there or that the first element needs to precede the second element in some manner. For example, when the English articles such as “a,” “an,” and “the” are added in the present disclosure through translation, these articles include the plural unless clearly indicated otherwise in context.

### REFERENCE SIGNS

1: Mobile communication system
10: RAN
20: CN
100: UE
110: Receiver
120: Transmitter
130: Controller
200: gNB
210: Transmitter
220: Receiver
230: Controller
240: Backhaul communicator

1. A communication method executed by a user equipment communicating with a first cell in a mobile communication system providing a multicast and broadcast service (MBS), the communication method comprising
transmitting, to the first cell, a message related to an MBS reception timing for the user equipment to perform MBS reception from a second cell belonging to a frequency different from a frequency to which the first cell belongs.

2. The communication method according to claim 1, further comprising
after the transmitting of the message, receiving, from the first cell, an MBS gap configuration indicating a configuration of a gap for the MBS by which communication with the first cell is suspended to perform the MBS reception from the second cell.

3. The communication method according to claim 2, further comprising
by the user equipment in a radio resource control (RRC) connected state in the first cell, suspending the communication with the first cell and performing the MBS reception from the second cell in the gap for the MBS, based on the MBS gap configuration.

4. The communication method according to claim 2, wherein
the transmitting comprises transmitting the message comprising requested gap information indicating the configuration of the gap for the MBS requested by the user equipment.

5. The communication method according to claim 4, further comprising
generating the requested gap information, based on a configuration of a multicast control channel (MCCH) of the second cell and/or a configuration of a multicast traffic channel (MTCH) of the second cell.

6. The communication method according to claim 2, wherein
the transmitting comprises transmitting, to the first cell, the message comprising configuration information indicating a configuration of a multicast control channel (MCCH) of the second cell and/or a configuration of a multicast traffic channel (MTCH) of the second cell.

7. The communication method according to claim 1, further comprising
after the transmitting of the message, receiving, from the first cell, a paging reception configuration related to a configuration of a paging reception timing for the user equipment to receive paging from the first cell.

8. The communication method according to claim 7, further comprising
by the user equipment in a radio resource control (RRC) idle state or an RRC inactive state in the first cell, based on the paging reception configuration, monitoring the paging from the first cell at the paging reception timing and performing the MBS reception from the second cell at a timing different from the paging reception timing.

9. The communication method according to claim 7, wherein
the transmitting comprises transmitting, to the first cell, the message comprising request information requesting a change of the paging reception timing.

10. A communication method executed by a network apparatus in a mobile communication system providing a multicast and broadcast service (MBS), the communication method comprising
receiving, from a user equipment via a first cell, a message related to an MBS reception timing for the user equipment to perform MBS reception from a second cell belonging to a frequency different from a frequency to which the first cell belongs.

11. The communication method according to claim 10, wherein
the network apparatus is a base station configured to manage the first cell, and
the communication method further comprises transmitting, based on the message, an MBS gap configuration to the user equipment via the first cell, the MBS gap configuration indicating a configuration of a gap for the MBS by which communication with the first cell is suspended to perform the MBS reception from the second cell.

12. The communication method according to claim 11, wherein
the receiving comprises receiving the message comprising requested gap information indicating the configuration of the gap for the MBS requested by the user equipment.

13. The communication method according to claim 11, wherein
the receiving comprises receiving the message comprising configuration information indicating a configuration of a multicast control channel (MCCH) of the second cell and/or a configuration of a multicast traffic channel (MTCH) of the second cell.

14. The communication method according to claim 10, wherein
the network apparatus is a paging management apparatus configured to manage paging in the first cell, and
the communication method further comprises transmitting, based on the message, a paging reception configuration to the user equipment via the first cell, the paging reception configuration being related to a configuration of a paging reception timing for the user equipment to receive paging from the first cell.

15. The communication method according to claim 14, wherein
the receiving comprises receiving the message comprising request information requesting a change of the paging reception timing, and
the transmitting comprises transmitting the paging reception configuration by which the paging reception timing is configured to not overlap the MBS reception timing in the second cell, based on the request information.

16. The communication method according to claim 1, wherein
the first cell is a cell belonging to a first public land mobile network (PLMN), and
the second cell is a cell belonging to a second PLMN different from the first PLMN.

17. The communication method according to claim 1, wherein
the MBS reception is reception of an MBS session provided in Receive-Only Mode (ROM).

18. The communication method according to claim 1, wherein
the MBS reception is reception of an MBS session provided in Free-To-Air (FTA).

19. A communication method executed by a user equipment communicating with a first cell in a mobile communication system providing a multicast and broadcast service (MBS), the communication method comprising:
receiving, from the cell, broadcast information indicating an MBS session being provided by the cell in Receive-Only Mode (ROM) and/or Free-To-Air (FTA); and
identifying the MBS session being provided by the cell in the ROM and/or the FTA, based on the broadcast information.
